(19) United States
(12) Patent Application Publication
(10) Pub. No.: US 2007/0200370 A1
(43) Pub. Date: Aug. 30, 2007

(54) Gliding door latch assembly with anti-activation mechanism

(76) Inventor: Joseph G. Reithmeyer, Afton, MN (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/655,552

(22) Filed: Jan. 19, 2007

Related U.S. Application Data
(60) Provisional application No. 60/760,853, filed on Jan. 20, 2006.

(51) Int. Cl. E05B 15/02

(52) U.S. Cl. 292/340

(57) ABSTRACT

A latch for a gliding door unit includes a latch assembly mounted in the leading edge of a gliding door and a complementing keeper assembly mounted in the facing jamb of the door unit. The latch assembly has a face plate from which a latch can be deployed by operation of a handle on the gliding door. The keeper assembly has a strike plate and a keeper. The door is latched shut by sliding the gliding door against the jamb and operating the handle, whereupon the latch deploys from the face plate to lodge behind and capture the latch. The latch mechanism includes an anti-activation mechanism that includes a depressible trigger projecting from the face plate toward a target zone on the strike plate. The latch is operable when the trigger is depressed and is prevented from being operated when the trigger is extended. A fault aperture is formed in the strike plate below the target zone. As long as the strike plate and the face plate are substantially aligned, the trigger engages and is depressed by the target zone of the strike plate when the door is slid shut, thus allowing operation of the latch to latch and lock the door. If the door becomes downwardly displaced with respect to the jamb so that the latch might not securely capture the keeper if deployed, the trigger does not engage the target zone but instead extends into the fault aperture and is not depressed. The resulting inability of a user to operate the handle to deploy the latch serves as an indication or warning to the user of a misalignment of the door that should be repaired.

### CROSS-REFERENCE TO RELATED APPLICATION

Benefit is hereby claimed of the filing date of U.S. Provisional Application No. 60/760,853, filed Jan. 20, 2006, which is incorporated by reference herein it its entirety.

### FIELD OF THE INVENTION

This invention relates generally to gliding doors (sometimes referred to as sliding doors or patio doors), and more particularly to latch assemblies for gliding doors.

### BACKGROUND OF THE INVENTION

An important aspect of any door that provides access to a residence or other building is its ability to be latched and locked reliably. “Locked reliably” and terms of similar import mean that the door can be consistently locked securely, and, in addition, that a failure to lock securely is indicated in some manner or otherwise is apparent to a user. In traditional hinged entry doors, for example, a failure of the door's latch mechanism to engage properly usually is apparent, either by the absence of a familiar clicking sound or through pushing or pulling the door to verify that the door has latched shut. In a typical sliding or gliding door unit, the movable gliding door panel is provided with a latch mechanism and the jamb is provided with a strike plate having an opening that houses a keeper. When the gliding door is slid shut, the latch mechanism aligns next to the strike plate and is operated by a user, usually by rotating a handle of the mechanism. This causes a latch having a hooked end to pivot outwardly and upwardly from the edge of the door panel into the opening of the strike plate. Further rotation of the handle causes the hooked end of the latch to move up behind and thus to hook the keeper, which usually is positioned at or near the top of the opening. Still further rotation of the handle pulls the latch slightly back into the latch mechanism and toward the gliding door. This action pulls and seats the leading edge of the door panel tightly within the jamb channel, compresses weather stripping within the channel to form a seal, and locks the door securely shut.

Misalignment of the gliding door panel relative to its jamb can cause malfunction of the latch mechanism resulting in a failure of the door to latch, seal, and lock properly. Some types of misalignment and malfunction generally are apparent to a user. For instance, if the frame of the gliding door panel is bowed in or out due to temperature differentials, high wind, or physical damage, the frame will not move into the jamb channel when the door is closed but instead will hit the inside or outside wall of the jamb channel and rebound. The defective condition thus is readily apparent. Similarly, the gliding door panel and its latch mechanism may become aligned too high relative to the jamb and strike plate. This can be caused, for example, by a crowning of the sill or settlement of the structure in which the gliding door unit is mounted. In either event, the latch is aligned too high relative to the keeper when the door is shut. Accordingly, when a user slides the door shut and attempts to operate the latch mechanism, the latch may impact the strike plate or prematurely hit the keeper as the latch rotates upwardly. The latch thus becomes jammed and the handle of the assembly cannot be fully rotated to its locked position, or rotation of the handle pushes the door panel back open. Again, the user is alerted to the fault condition by the fact that the latch mechanism fails to operate properly when the user tries to latch the door.

In some circumstances, a failure of a gliding door panel to latch and lock might not be readily apparent to a user as in the bowing or high door panel misalignment fault conditions discussed above. A particular type of misalignment that can lead to such a condition is when the gliding door panel and its latch mechanism is misaligned too low relative to the jamb and strike plate. The latch mechanism thus becomes downwardly displaced relative to the strike plate and keeper when the door is slid shut. Under these circumstances, the latch mechanism may still be able to be operated by a user in the normal manner, but the latch rotates into the lower portion of the strike plate opening below the keeper at the top of the opening. As a result, the latch is too low to hook the keeper and fails to capture the keeper. Accordingly, although the gliding door panel is closed and the latch mechanism appears to have operated normally (i.e. it is rotated through its full normal range), in reality the door is not locked and can easily be slid open by an intruder or would be thief.

The prior art includes attempted solutions to this problem. For example, U.S. Pat. No. 5,595,409 of Fier et al. describes a latch and keeper assembly for a gliding door. The latch mechanism on the edge of the gliding door panel has a button that must be depressed into the latch mechanism before the latch can be operated. The strike plate on the jamb is provided with a rigid projecting spike that engages and depresses the button on the latch mechanism when the gliding door panel is properly aligned with the jamb and slid shut. If the door is misaligned, the spike misses the button, which consequently is not depressed. Thus, the latch mechanism will not operate, and the inability of the user to operate the latch is a clear indication of a misalignment fault that prevents the door from latching and locking properly. While this approach has been somewhat successful, it nevertheless has proven to have certain inherent problems and shortcomings. For instance, if the gliding door panel becomes misaligned with the jamb and is slid shut, the rigid spike on the strike plate is rammed into the edge plate of the latch mechanism at a location next to the button rather than engaging and depressing the button. Experience has shown that this can cause substantial damage and disfigurement of the latch mechanism. It also commonly causes the spike to be bent or crushed in such a way that it lodges between the strike plate and the latch mechanism when the door is closed, thus jamming the door and preventing it from closing completely. If the damaged spike is removed so that the door can be closed, the latch nevertheless cannot be operated to lock the door because the spike is not available to depress the activation button of the latch mechanism. Major repair or replacement is thus typically required.

Accordingly, a need exists for a latch assembly for gliding door units that addresses the problems arising from door panel misalignment and the shortcomings of the prior art, as discussed above. Such an assembly should either latch and lock reliably and securely when activated by a user or, if a securely latched and locked condition is not obtained, provide clear indication of a fault condition to the user, particularly in a low door misalignment condition. Further, the assembly should not be prone to disfigurement or damage should the door panel become misaligned. It is to the provision of such a latch assembly that the present invention is primarily directed.

### SUMMARY OF THE INVENTION

Some aspects of the latch assembly of the present invention, and particularly many internal working components of the latch mechanism, are the same as or similar to those of latch assemblies disclosed in U.S. Pat. Nos. 5,595,409 and 5,775,749, both owned by the assignee of the present invention. These patents are therefore incorporated fully by reference, and should be referred to for detailed teachings and background relevant to the present invention.

Briefly described, the present invention, in one embodiment thereof, is a latch assembly for a gliding door unit for reliably locking a gliding door panel in a closed position relative to a frame in which the door panel glides. The latch assembly incorporates a unique anti-activation mechanism that prevents the latch from being operated by a user, or restricts its operation, when certain door panel misalignments or “fault conditions” exist that prevent proper locking. The inability of a user to operate the latch under such conditions serves as a clear indication or warning to the user that a fault condition exists. In the preferred embodiment, the assembly includes a latch mechanism on the gliding door panel substantially similar in operation to the latch mechanisms disclosed in the incorporated patents. However, the latch mechanism in the present invention includes a trigger that projects outwardly from the leading edge of the door panel, but that can be depressed into the latch mechanism against the force of a biasing spring. When the trigger is depressed, the latch mechanism can be operated normally. When the trigger is not depressed, the latch mechanism is prevented from being operated. The strike plate on the door jamb, which houses the latch keeper, includes a target area that aligns with the trigger of the latch mechanism when the door is properly aligned with the jamb and slid shut. When the door is slid shut, the trigger engages the strike plate within the target area and is depressed into the latch mechanism as the leading edge of the door panel moves into the jamb channel. The latch mechanism can then be operated in the normal way to lock the door.

In the event of a bowed door panel or a high door misalignment fault condition, the latch mechanism fails to operate for the same reasons as in the prior art discussed above, thus clearly indicating the misalignment fault to a user. However, a low door misalignment condition is addressed differently than the prior art. More specifically, a fault aperture is formed in the strike plate beneath the target area. In the event that the door and its latch mechanism becomes displaced downwardly more than a predetermined amount relative to the door jamb and strike plate, the trigger on the latch mechanism misses the target area on the strike plate and, instead, aligns with and extends into the fault aperture when the door is slid shut. Thus, under these conditions, the trigger is not depressed when the door is closed, and, accordingly, the latch mechanism cannot be operated by the user. The low displacement fault condition is therefore apparent to the user. However, in contrast to the rigid projecting spike approach of the prior art, the trigger is not impaled against the strike plate under these conditions, but rather simply extends undamaged into the fault aperture in the strike plate. Thus, damage to the latch mechanism is eliminated. Further, the trigger of the present invention is not bent or crushed between the latch mechanism and the strike plate because it is not rigidly attached but rather depresses smoothly into the latch mechanism under conditions of proper alignment. Accordingly, the jamming and consequent door unit repair or replacement common in the prior art is eliminated.

The present invention is illustrated and described with reference to various preferred embodiments. One embodiment is intended for use in connection with a gliding door unit having at least one door panel that glides within a door frame. When the door is slid against the jamb, operation of the latch assembly seats the door to the jamb and locks the door shut against the jamb. In this embodiment, a latch mechanism is secured to the frame of the gliding door panel, and a strike plate with keeper is secured within a vertical jamb forming a part of the door frame. In an alternative type of gliding door unit, sometimes referred to as a four-panel unit, two gliding door panels and one or two fixed panels are provided. The latch mechanism, including its depressible trigger, is mounted within the frame of one gliding door panel and the strike plate with keeper is mounted within the frame of the other gliding door panel facing the latch mechanism. The trigger aligns with and engages the target area of the strike plate and is depressed when the door panels are properly aligned and closed together so that operation of the latch assembly locks the doors one to the other. In this embodiment, the latch assembly preferably includes a locating pin on the strike plate and a corresponding hole in the latch mechanism for effecting small corrections to the relative alignment of the two gliding door panels as they are closed together and locked.

The foregoing and other features, objects, and advantages of the present invention will become more apparent upon review of the detailed description set forth below taken in conjunction with the accompanying drawing figures, which are briefly described as follows.

### BRIEF DESCRIPTION OF THE DRAWINGS

FIG. 1 is a front plan view of a two panel gliding door unit that includes a latch mechanism embodying principles of the present invention.

FIG. 2 is a perspective view of one embodiment of the present invention showing a latch assembly in the edge of a gliding door and a keeper assembly in a jamb.

FIG. 3 is an exploded perspective view of a latch assembly with an anti-activation mechanism that embodies principles of the invention in one embodiment.

FIG. 4 is an exploded perspective view of the trigger unit and rocker plate of an anti-activation mechanism according to one embodiment of the present invention.

FIG. 5 is a is a perspective view of the trigger unit and rocker plate of FIG. 4 showing their functional interaction with one another.

FIG. 6 is an exploded perspective view of the trigger unit and rocker plate of FIGS. 4 and 5 as seen from the reverse side and illustrating the second cam and cam follower surfaces and placement and function of the coil spring.

FIG. 7 is a side plan view, partially in section, of the latch and keeper assemblies illustrating functioning of the anti-activation mechanism to prevent operation of the latch in a low door alignment fault condition.

FIG. 8 is a side plan view of the latch and keeper assemblies of FIG. 7 illustrating function of the anti-activation mechanism to permit operation of the latch in a proper door alignment condition.

FIG. 9 is a side plan view of an anti-activation mechanism that embodies principles of the invention in an alternate embodiment.

FIG. 10 is a plan view of another style of gliding door unit to which the present invention may be applied.

FIG. 11 is a perspective view of a latch assembly in the edge of one gliding door and a keeper assembly in an edge of an adjacent gliding door of the door unit shown in FIG. 10.

### DETAILED DESCRIPTION

For a more complete understanding of the present invention, reference is now made to the following detailed description and accompanying drawings, wherein like reference numerals designate, where appropriate, like parts throughout the various views.

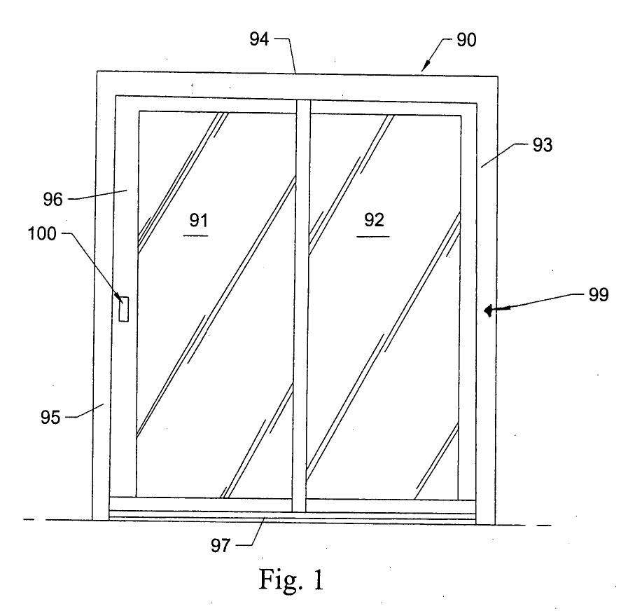

FIG. 1 illustrates a two-panel sliding or gliding door unit 90, including a door frame 99 within which is mounted a gliding door panel 91 and a fixed door panel 92. The door frame 99 includes a pair of vertical jams 93 and 95, a horizontal head jamb 94 extending between the upper ends of the vertical jambs 93 and 95, and a horizontal sill 97 extending between the lower ends of the vertical jambs 93 and 95. The horizontal sill 97 further includes or is formed with a track (not visible) to enable the gliding panel 91 to glide between an open position substantially overlying fixed panel 92 and a closed position against jamb 95 as illustrated in FIG. 1. The fixed panel 92 may be secured relative to the door frame 99 so that it does not glide. The gliding door panel 91 has a frame that surrounds the glass of the door panel. The frame includes a vertical leading frame member 96, within which is mounted a latch mechanism, generally indicated at 100, that embodies principles of the present invention, as discussed in detail below. A strike plate and keeper assembly (not visible in FIG. 1) is secured to the inside edge of vertical jamb 95 and is aligned with and cooperates with the latch mechanism 100 to permit the gliding panel 91 to be securely locked in its closed position by a user.

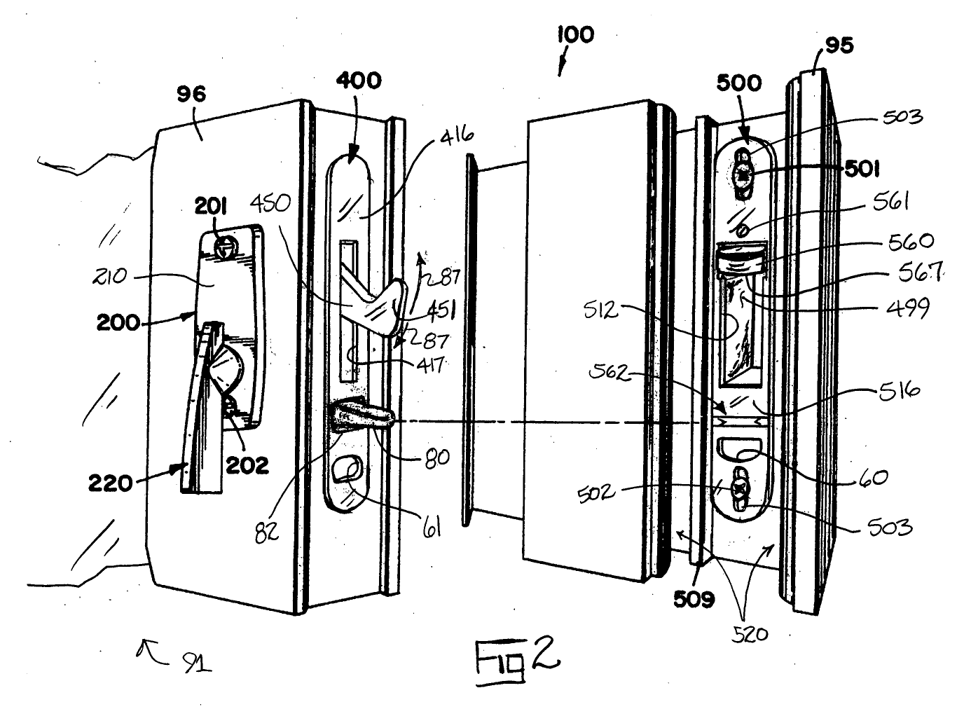

FIG. 2 is a perspective view of a portion of the leading frame member 96 of the gliding door panel 91 and a portion of the vertical jamb 95, and illustrating the latch assembly of the present invention. The gliding door panel 91 has a vertical leading frame member 96 in which the latch mechanism 400 of this invention, in one embodiment, is mounted. The inside edge of the jamb 95, i.e. the edge facing the gliding door panel, is formed with a jamb channel 520 sized to receive the edge of the leading frame member 96 when the gliding door panel 91 is slid shut. Flexible weather stripping 509 preferably is disposed within the jamb channel 520. The latch mechanism 400 includes a metal face plate 416 exposed on the edge of the leading frame member 96. The face plate 416 is formed with an elongated slot 417, a trigger port 82, and an alignment aperture 61. As detailed below, alignment aperture 61 helps to align two gliding doors in an embodiment where the first door latches to the second rather than to a jamb.

The elongated slot 417 is sized to accommodate a latch 450 having a hooked end 451. More specifically, the slot 417 is sized and positioned to allow the latch 450 to swing up and out of the latch mechanism and down and back into the latch mechanism in the directions of arrows 87. The latch mechanism 400 also includes a handle assembly 200 on one face of the leading frame member 96, usually the inside face. The handle assembly 200 includes a face plate 210 to which a handle 220 is rotatably mounted, as detailed below. The face plate is mounted to the leading frame member 96 by means of screws 201 and 202, which may extend through the latch mechanism inside the leading frame member and thread into a corresponding plate on the exterior face of the leading frame member, which may include a key operator. As described in more detail below, rotation of the handle 220 in one direction causes the latch 450 to swing out and up to a substantially horizontal orientation, and then to be drawn slightly back into the latch mechanism into it latched position. Rotation of the handle 220 in the other direction causes the latch 450 to reverse this motion, first moving slightly outwardly from the latch mechanism and then swinging down and in until the latch is stowed inside the latch mechanism in its unlatched position.

The latch mechanism further includes a depressible trigger 80, which normally is biased to project outwardly from the trigger port 82 as shown in FIG. 2 but that can be depressed into the latch mechanism with reasonably small force. As will become more apparent, the trigger 80 is an integral component of the anti-activation mechanism of the present invention, which is described in detail below. Generally speaking, however, the anti-activation mechanism is configured such that when the trigger is in its extended position as shown in FIG. 2, the range of movement of the latch 450 outwardly from the slot 416 is limited so that the latch 450 cannot move all the way into its latched position. This condition is apparent to a user because the handle 220 jams and cannot be completely rotated through its normal range. The alignment aperture 61 is disposed below the trigger port 82 and trigger 80 for purposes described in detail below.

The strike plate and keeper assembly 500 includes a metal strike plate 516 adjustably attached to the jamb 95 within the jamb channel 520 by means of screws 501 and 502 that extend through slotted adjustment openings 503. The strike plate 516 is formed with a generally rectangular keeper opening 512 and a box-shaped housing 499 may be attached to the back of the strike plate behind the keeper opening to form a cavity. A keeper 560 is fixed at the top of the keeper opening. The keeper 560 has a downturned lip 567. Preferably, the keeper is laterally adjustable within the keeper opening 512 by means of an adjustment screw 561 such that rotation of the adjustment screw 561 moves the downturned lip 562 of the keeper toward and away from the jamb 95. This allows adjustment of the seal between the edge of the gliding door panel and the jamb. The strike plate 516 has a target zone 562, which is marked with appropriate indicia such as the demarcation lines and pointers shown in FIG. 2. Disposed a predetermined distance below the target zone 562 is fault aperture 60, which, in the preferred embodiment, has a rounded bottom edge and a substantially straight top edge.

Under normal conditions, i.e. when the gliding door panel is properly aligned with the jamb, the gliding door panel 91 can be closed and locked as follows. The door is slid toward the jamb 95 so that the edge of the leading frame member 96 moves into the jamb channel 520. This brings the face plate 416 of the latch mechanism 400 into aligned close proximity with the strike plate 516 of the strike plate and keeper assembly 500. The slot 417 of the face plate 416 also is brought into substantial alignment with the keeper opening 512. As the leading frame member 96 begins to move into the jamb channel 520, the depressible trigger 80 engages the strike plate 516 within the target zone 562. Further movement of the leading frame member 96 causes the trigger 80 to be depressed into the latch mechanism a sufficient distance to permit the latch mechanism to be operated by rotating the handle 220 through its full range of movement. This distance is selected such that the latch mechanism cannot be operated unless it is sufficiently close to the strike plate to latch and lock securely.

With the gliding door panel 91 slid shut, and the trigger sufficiently depressed, rotation of the handle 220, usually located on the interior side of the leading frame member 96, swings the latch 450 out and up in the direction of arrow 87 until the hooked end 451 of the latch 450 moves behind the downturned lip 567 of the keeper 560. Continued rotation of the handle 220 draws the latch 450 back slightly into the latch mechanism 400 and thereby pulls the leading frame member 96 into tight engagement with the jamb 95 and within the jamb channel 520. This action compresses the weather stripping 509 between the edge of the leading frame member 96 and the jamb to seat and seal the frame member 96 within the jamb channel 520. The gliding door panel is thus securely latched and locked shut.

The forgoing procedure is used to close and lock the gliding door panel 91 under normal conditions, i.e. when the door panel is plumb and properly aligned vertically and horizontally with the jamb 95. Many of the advantages of the present invention over the prior art, however, are most clearly revealed when the gliding door panel becomes misaligned with the door frame so that a secure latch and lock cannot be obtained simply by sliding the door shut and turning the handle. As discussed above in the background section, types of misalignment include lateral misalignment due to door panel warpage, temperature differentials, or high wind pressures; high misalignment where the latch mechanism aligns too high relative to the strike plate; and low misalignment where the latch mechanism aligns too low relative to the strike plate. The latch mechanism of the present invention functions quite differently under these conditions than the rigid spike on the strike plate and button on the latch mechanism typical of the prior art. For example, and referring again to FIG. 2, if the gliding door panel 91 becomes warped or otherwise laterally misaligned relative to the jamb 95, it will hit the sides of the jamb channel 520 when slid shut rather than slipping into the jamb channel. The misalignment, and consequent inability to lock the door securely, is thus apparent to the user, who can take corrective action. In a high misalignment condition, the latch mechanism 400 is aligned too high relative to the strike plate and keeper 500. The latch 450 is therefore too high to swing all the way up to its horizontal orientation so that its hooked end 451 can capture the keeper 560. Instead, even though the trigger 80 engages the strike plate 516 above the target zone and is depressed to allow rotation of the handle, the latch 450 nevertheless hits or jams against the keeper 560 when it is only partially deployed, thereby preventing further rotation of the handle. Again, the fault condition and failure to obtain a secure lock is apparent to the user. As mentioned, this high misalignment condition causes the trigger 80 to impact the strike plate 516 at a location above the target zone 562. However this is of little moment with the present invention since the trigger 80 is merely depressed into the latch mechanism in the usual way. This contrasts greatly with the prior art, where the high misalignment condition causes the rigid spike on the strike plate to miss its button on the latch mechanism, jam into the face plate causing disfigurement, and often caused the spike to be bent by the impact so that it is no longer functional. These problems are completely eliminated by the present invention.

A low misalignment condition reveals more unique operational features of the present invention. In such a condition, the latch mechanism 400 is aligned too low relative to the strike plate 500 so that the latch 80, if fully deployed, would be too far below the keeper 560 to capture the keeper and a secure lock could not be obtained. However, with the present invention, the low misalignment causes the trigger 80 to fall below the target zone 562 on the strike plate. This, in turn, results in the trigger 80 extending into the fault aperture 60 as the gliding door 91 is slid shut. Thus, the trigger 80 simply does not get depressed when the door shuts, but remains in its extended position within the fault aperture 60. Again, this contrasts with the rigid spike and button of the prior art, where the spike jams against the strike plate when missing the button on the latch mechanism, often causing permanent damage. In any event, since the trigger 80 is not depressed, the user is unable to rotate the handle 220 beyond a minimal degree until it stops. The inability of the user to rotate the handle serves as a clear indication that a fault condition exists that prevents the door from being locked securely, however, no disfigurement or damage has occurred and, once the misaligned condition is corrected, the trigger 80 again engages the strike plate in the target zones and the latch mechanism functions normally.

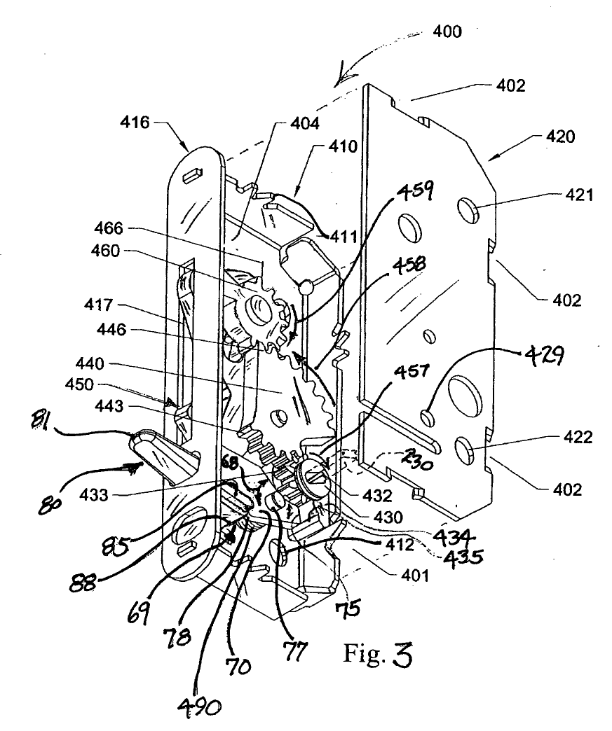

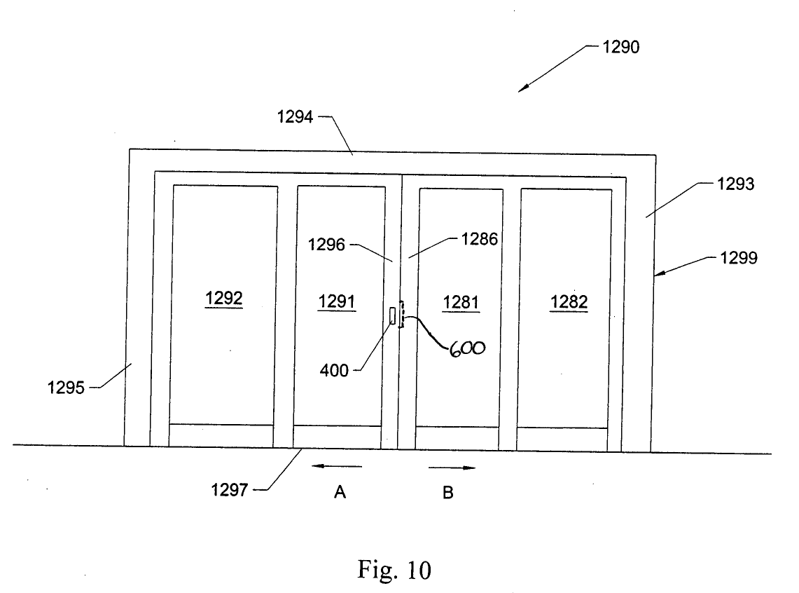

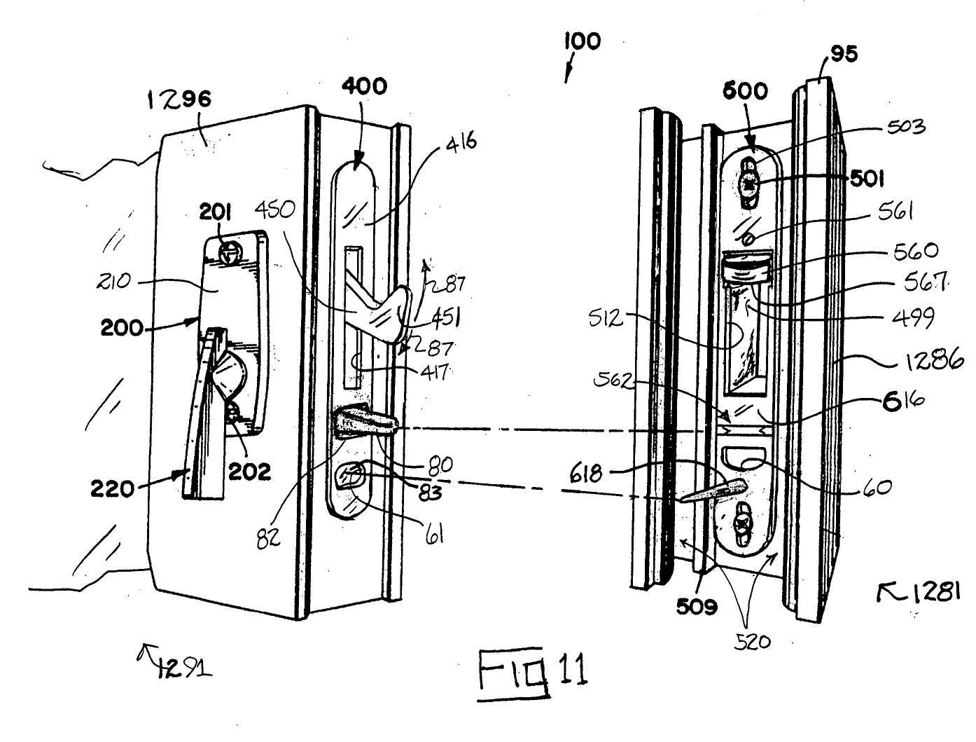

FIG. 3 illustrates the internal working components of the latch mechanism 400, which includes an embodiment of the anti-activation mechanism of the present invention. Here, it should be noted that many of the working components shown in FIG. 3 are the same as those disclosed and discussed in substantial detail in incorporated U.S. Pat. No. 5,595,409 (the '409 Patent). More specifically, the configuration and operation of the gear train including crank gear 430, linking gear 440, and latch gear 460 are depicted in FIGS. 14-17 and discussed in detail beginning at column 6, line 56 of the '409 Patent. Further, the configuration and operation of the latch assembly to cause the latch 450 to swing up and out of the latch mechanism and then to be drawn slightly back into the latch mechanism upon rotation of the handle 220 is depicted in FIGS. 10-12 and 18-21 as well as in FIGS. 14-17 of the '409 Patent. These figures are discussed in detail beginning at column 6, line 36 of the '409 Patent. Accordingly, a detailed description of the configuration and operation of these components of the latch mechanism will not be presented again here, but reference is instead made to the incorporated '409 Patent for such details.

Generally speaking, however, and with reference again to FIG. 3, the latch mechanism 400 includes a box-like shell 410 and a side plate 420 that normally is secured to the shell 410 with appropriate flanges 411 that fit into recesses 402, to enclose the internal components of the latch mechanism. The shell 410 includes a shell plate 404 that is essentially similar to the side plate 420. The side plate 420 and shell plate 404 are punched or otherwise formed with appropriate holes, grooves, and slots to support and promote operation of the gear train and latch assembly, as detailed in the '409 Patent. The handle assembly 200 (FIG. 2) includes a rectangular rod 230, shown in phantom lines in FIG. 3, that extends through a keyway 432 in the crank gear 430. Rotation of the handle 220 rotates the rectangular rod 230, which, in turn, rotates the crank gear 430 to operate the latch mechanism. More specifically, rotation of the handle 220 in the proper direction to lock the gliding door causes the crank gear 430 to rotate in the direction of arrow 457. This causes linking gear 440 to rotate in the direction of arrow 458, which, in turn, causes latch gear 460 to rotate in the direction of arrow 459. This rotation of latch gear 459, then, causes the latch 450 first to swing out and up from the slot 417 to a substantially horizontal orientation, and then to be drawn slightly back into the latch mechanism to complete its locking motion. The detailed configuration of the latch gear 460, latch 450, and shell plate 404 that results in this motion is described in detail in the incorporated '409 Patent, and thus will not be detailed again here.

With continuing reference to FIGS. 3 through 6, the latch mechanism 400 includes an anti-activation mechanism 69 that embodies the present invention. The anti-activation mechanism 69 includes trigger 80, rocker plate 70, and crank gear 430. Rocker plate 70 has a pivot shaft 77 that is rotatably journalled at its ends in corresponding holes, e.g. hole 429, in the. shell plate 404 and the side plate 420. Accordingly, the rocker plate 70 is pivotable or rotatable about the axis of pivot shaft 77 in the direction of arrows 68. A coil spring 490 is disposed about pivot shaft 77 adjacent the back plate 404 and acts to bias the rocker plate 70 to the position in which it is shown in FIG. 3, referred to herein as its first position. The spring also biases the trigger 80 outwardly to its projecting position. The rocker plate 70 is formed with an inclined cam follower surface 78 along its bottom edge and with a stop 75 at its back edge. The trigger 80 has, in addition to its projecting external portion with tip 81, an internal portion disposed within shell 410 of the latch mechanism. The internal portion of the trigger 80 is described in more detail below. Generally, however, the internal portion of trigger 80 is formed with a cam surface 88 that engages the cam follower surface 78 of the rocker plate 70. When the trigger 80 is depressed into the latch mechanism, the cam surface 88 moves to the right in FIG. 3. As the cam surface moves, the cam follower surface 78 rides up the cam surface 88 causing the rocker plate 70 to rotate about pivot shaft 77 in a clockwise direction from the first position wherein it prevents rotation of crank gear 430 to a second position wherein the stop 75 is downwardly displaced a predetermined distance thereby allowing rotation of crank gear 430. Thus, depression of projecting portion 80 of the trigger unit 89 rotates the rocker plate from its first position to its second position. Conversely, release of the projecting portion of the trigger allows it to extend back out under the influence of the spring 490, which moves the rocker plate from its second position back to its first position, where, once again, it prevents rotation of crank gear 430.

The crank gear 430 is formed with a downwardly projecting finger 434 that has a stop surface 435. The finger 434 is an integral part of and rotates with the crank gear 430 as a user rotates the handle 220 to operate the latch mechanism. It will be apparent from FIG. 3 that, with the trigger 80 extended and the rocker plate thus in its first position, the stop 75 of the rocker plate 70 is positioned in the path of the stop surface 435 of finger 434. Accordingly, when a user attempts to rotate the handle 220 with the trigger extended, the stop surface 435 of finger 430 relatively quickly engages the stop 75 of the rocker plate, which jams the crank gear 430 and prevents further rotation of the handle 220. The anti-activation mechanism 69 thus prevents activation of the latch mechanism as long as the finger 80 is in its extended position as shown in FIG. 3. However, as detailed below, when the projecting portion of the trigger 80 is depressed to the right in FIG. 3 into the latch mechanism, the rocker plate 70 is rotated by cam surface 88 to its second position. In this second position, the stop 75 of the rocker plate 70 is positioned downwardly and out of the path of the stop surface 435. Thus, when the trigger is depressed and a user attempts to rotate the handle 220, the finger 434 passes above the stop 75 of the rocker plate 70 and its movement is not blocked. The crank gear can thus be rotated through its full range so that the latch 450 is completely deployed. The trigger 80 normally is depressed by engagement with the strike plate when the gliding door panel is properly aligned and slid shut. Accordingly, under these conditions, which represent normal operation, a user simply slides the gliding door panel shut and rotates the handle to lock the gliding door panel securely.

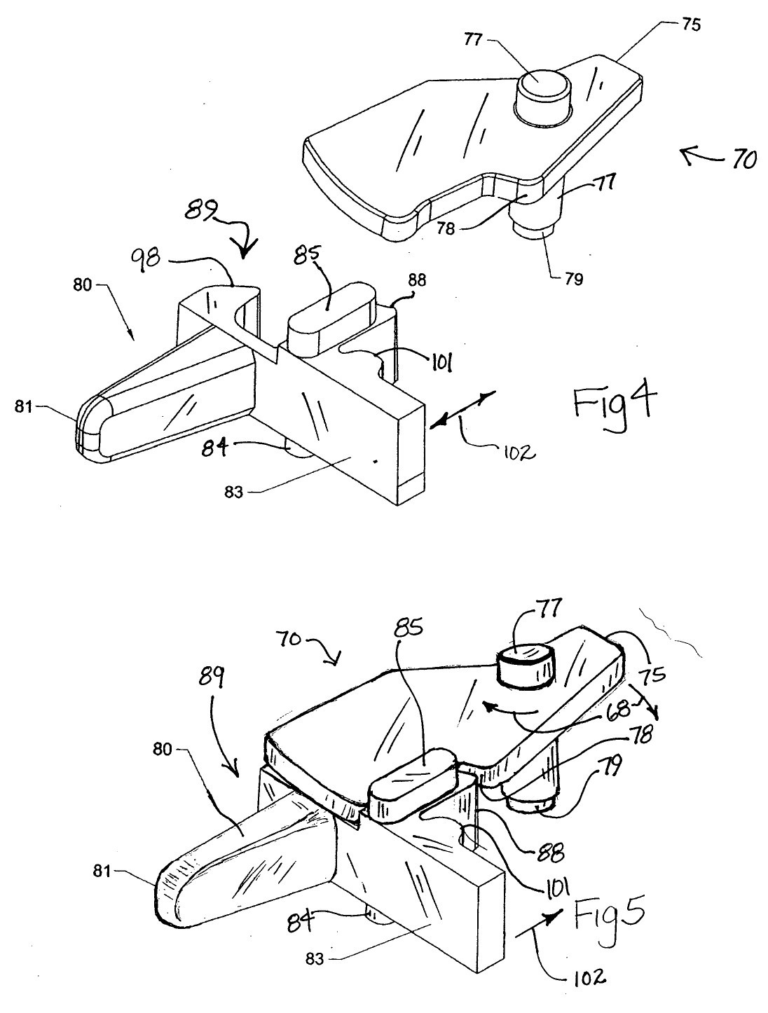

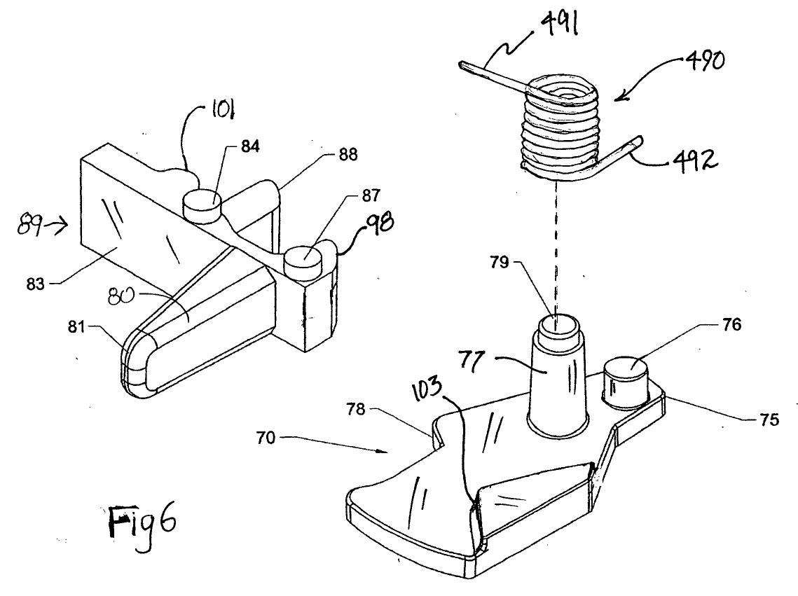

FIGS. 4-6 detail the trigger unit 89 and rocker plate 70 and their operation, with FIG. 4 illustrating these two components in exploded perspective, FIG. 5 illustrating them in their operational positions relative to each other, and FIG. 6 showing features on the underside of the trigger unit and rocker plate. Referring to FIGS. 4 and 6, the trigger unit 89, which preferably is formed of molded plastic, includes trigger 80 that normally project out of the face plate 416 of the latch mechanism 400 (FIG. 3). The trigger 80 terminates in tip 81. The remaining portion of the trigger unit 89 resides inside the latch mechanism 400 and is formed to define, among other features, cam surface 88, secondary cam surface 98, slide shoe 85, and push block 83. Two slide bosses 84 and 87 (FIG. 6) are formed on the bottom of trigger unit 89 and a spring boss 101 is formed on the back side of the push block 83. The slide shoe 85 and slide bosses 84 and 87 journal and slide within corresponding slots formed in the shell plate 404 and side plate 420 (FIG. 3) to permit sliding movement of the trigger unit 89 in the direction of arrow 102 when the trigger 80 is depressed. With continuing reference to FIGS. 4 and 6, the rocker plate 70, which also preferably is formed of molded plastic, is configured with a cam follower surface 78, a stop 75, and a shaft 77, the bottom end of which terminates in a boss 79. In operation, the upper end of shaft 77 is rotatably journalled within a corresponding hole 429 in the side plate 420 (FIG. 3) and the boss 79 is rotatably journalled within a similar hole in the shell plate 404. Thus, the rocker plate 70 rotates about the axis of shaft 77 in the direction of arrow 68 in FIG. 3. As shown in FIG. 6, the rocker plate 70 is formed on its underside with a depending secondary cam follower surface 103, similar in shape to cam follower surface 78. Cam follower surface 103 engages and follows cam surface 98 of the trigger unit 89 when the trigger 80 is depressed. The shape and location of cam surface 103 reduces lateral forces on trigger unit 89 during the initial portion of its travel when being depressed, thereby reducing the likelihood of sticking during this portion of its travel. The use of two cam surfaces and two cam follower surfaces enhances balanced and reliable operation of the mechanism, although a single cam and cam follower may be employed and such is within the scope of the invention. A spring stop 76 also is formed on the bottom of the rocker plate 70 adjacent the stop 75. A coil spring 490 normally is disposed about shaft 77 on the bottom of the rocker plate 70 and includes projecting spring arms 491 and 492. When the coil spring 490 is mounted on shaft 77 as shown in FIG. 3, spring arm 491 bears against the spring rest 101 on the trigger unit 89 and spring arm 492 bears against spring stop 76 on rocker plate 70, each under the biasing influence of the spring. In this way, the coil spring 490 simultaneously biases the trigger to its extended position and biases the rocker plate to its blocking position, which are the positions in which these elements are shown in FIG. 3. Thus, as discussed above, when the trigger 80 is extended, stop 75 of rocker plate 70 resides in the path of stop surface 435 thereby preventing operation of the latch mechanism by a user.

FIG. 5 illustrates the trigger unit 89 and rocker plate 70 as they are positioned relative to each other when assembled within the latch mechanism 400 and when the trigger 80 is in its extended position as shown in FIGS. 2 and 3. The coil spring 490 is omitted in FIG. 5 for clarity of illustration; however, it will be understood, as discussed above, that the coil spring is disposed about the bottom portion of shaft 77 biasing both the trigger unit 89 and the rocker plate 70 to the positions in which they are illustrated in FIG. 5. It will be appreciated from FIG. 5 that when the trigger 80 is depressed into the latch mechanism 400, the entire trigger unit 89 is moved to the right in FIG. 5, in the direction of arrow 102, against the bias of coil spring 490. As the trigger unit 89 begins its movement, its cam surfaces 88 and 98 engage cam follower surfaces 78 and 103 respectively of the rocker plate 70. Continued movement of the trigger unit causes the cam follower surfaces 78 and 103 to ride up or follow cam surfaces 88 and 98. This, in turn, causes the rocker plate 70 to rotate about shaft 77 and against the bias of coil spring 490 in a clockwise direction, as indicated by arrows 68 in FIG. 5. The stop 75 is thus moved downwardly and out of the path of the stop surface 435 of the crank gear 430 thereby allowing the crank gear to rotate normally to operate the latch 450. Simply put, when the trigger 80 is in its extended position, the anti-activation mechanism of this invention is active and the latch mechanism cannot be operated. When the trigger is depressed, the anti-activation mechanism is inactivated and the latch mechanism can be operated in its normal manner to extend the latch 450 fully and lock the sliding door shut.

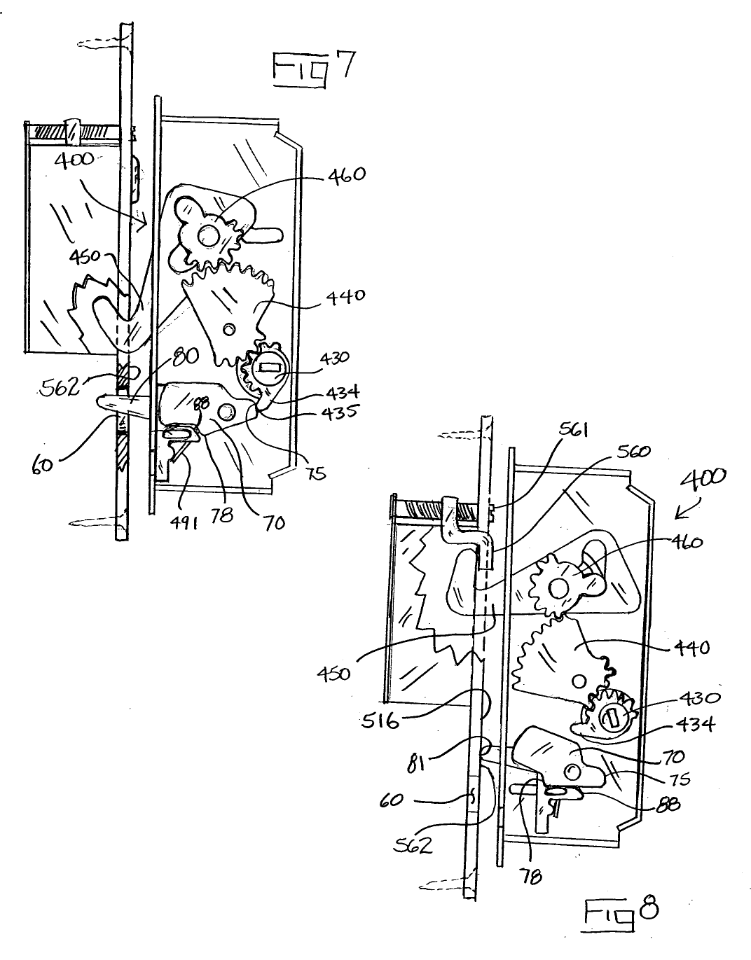

FIGS. 7 and 8 illustrate operation of the embodiment of the anti-activation mechanism detailed above. FIG. 7 shows the primary working components of the latch mechanism 400 as they are configured when the trigger 80 is in its extended position. The trigger 80 may be in this position when a sliding door bearing the latch assembly 400 is open; or, more importantly for the present invention, and as shown in FIG. 7, when the sliding door is slid shut but is downwardly misaligned an unacceptable amount with respect to the jamb. As discussed above, in this later condition, the trigger 80 aligns with and extends into the fault opening 60 in the strike plate 516 rather than engaging the strike plate in the target zone 562, and thus the trigger 80 is not depressed by the closing of the door. As can be seen in FIG. 7, in such a fault condition, the trigger 80 is extended and, as a consequence, the rocker plate 70 is biased by the spring (not visible) to its counter clockwise orientation. In this orientation, the stop 75 of the rocker plate 70 is rotated upwardly so that it resides in the path of the stop surface 435 of the arm 434 of the crank gear 430. If a user attempts, then, to latch the door by turning the handle 220, which is coupled to the crank gear 430, then the stop surface 435 of the crank gear hits the stop 75, as depicted in FIG. 7. As a consequence, the handle binds and can only be rotated a small amount by the user. In turn, the latch 430 does not deploy or only just begins to deploy, as shown in FIG. 7, when the handle 220 binds. The binding of the handle and incomplete latching operation serves as a positive indication to the user that the door is not latched and, further, that a defective alignment condition has developed that should be addressed promptly. Significantly, this occurs without a rigid spike having impacted the strike plate or the face plate of the latch mechanism as has been the case in the prior art. Thus, although a faulty alignment condition is clearly indicated to a user, this is done without any marring or any damage to the latch mechanism or to the strike plate. Further, once the misalignment condition is addressed, the latch mechanism resumes its normal latching operation.

FIG. 8 illustrates operation of the latch mechanism 400 to latch a sliding door when the door is properly aligned with the door jamb and slid shut. Under these conditions, the tip 81 of the trigger 80 engages the strike plate 516 within the target zone 562 as the door closes. This causes the trigger 80 to be depressed into the latch mechanism 400 as illustrated in FIG. 8. The inward displacement of the trigger 80 moves the cam surface 88, and also the cam surface 98 (FIG. 4) to the right in FIG. 8. As the cam surface 88 moves to the right, the cam follower surface 78 rides up the cam surface 88, causing the rocker plate 70 to rotate in a clockwise direction. This, in turn, moves the stop 75 of the rocker plate 70 downwardly and out of the path of finger 434 of crank gear 430. The crank gear 430 is unconstrained and rotates freely through its entire range in response to rotation of the handle 220 by the user. This is illustrated in FIG. 8, where the crank gear is shown fully rotated and, consequently, through linking gear 440 and latch gear 460, the latch 450 is fully deployed and latched behind the keeper 560. It will thus be clear that when the sliding door is properly aligned with the jamb and slid shut, the latch mechanism can be operated in its normal manner to latch and lock the sliding door securely to the jamb.

The fault aperture 60 should be made sufficiently wide in the horizontal direction to allow the trigger 80 to pass through when a combination of low door alignment and horizontal dislocation occurs. The shape of the fault aperture 60 is otherwise not necessarily limited, provided that the trigger 80 is able to pass through it when a low door alignment fault condition occurs, and the trigger 80 does not pass through it but rather engages the strike plate above the fault aperture and in the target zone 562 when no low door alignment fault conditions are present and door alignment is proper for secure latching.

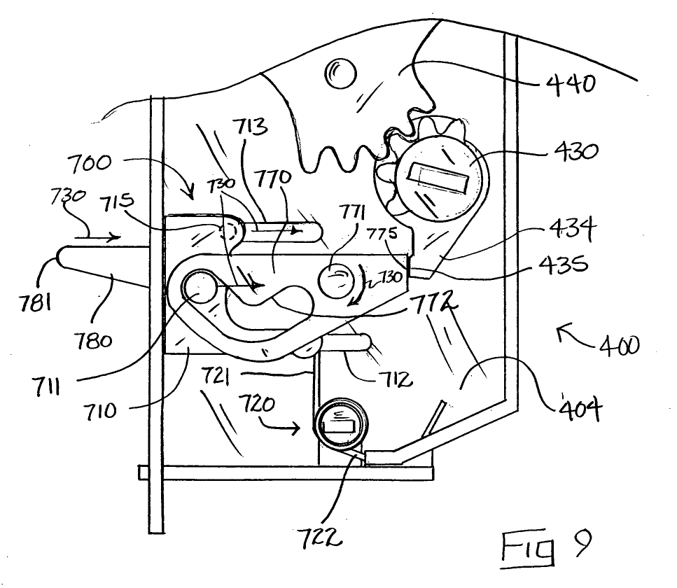

FIG. 9 illustrates an alternate embodiment of an anti-activation mechanism that also embodies principles of the present invention. Only the lower part of the latch assembly 400 is illustrated in FIG. 9 because all components other than the trigger, rocker plate, and spring are the same as and function in the same way as described above and as described in the patents incorporated herein by reference. Referring to FIG. 9, the anti-activation mechanism 700 of this embodiment comprises a unitarily molded trigger unit that includes a body 710 from which a trigger 780 having tip 781 projects. As with the previously described embodiment, the body 710 of the trigger unit resides within the latch mechanism 400 and the trigger 780 projects out of the face plate of the latch mechanism. The body 710 of the trigger unit is formed with projections 715, on the back side of the body 710 in FIG. 9, one of which is shown in phantom line. The projections 715 are disposed and ride or slide within elongated slots 712 and 713 formed in the shell plate 404 of the latch assembly 400. A coil spring 720 is mounted within the latch assembly and includes a first spring arm 721 that rests against the back of the body 710 and a second spring arm 722 that rests against the bottom of the latch assembly as shown. The coil spring thus urges the trigger unit to the left so that it is yieldably spring biased toward the position in which it is shown in FIG. 9 with its trigger 780 fully projecting from the latch assembly. It will thus be realized that the trigger unit is slidably mounted within the latch mechanism so that it is free to slide to the right in FIG. 9. Further, it is spring biased by coil spring 720 to a first extended position, in which it is shown in FIG. 9, and, upon depression of the trigger 780, is moved against the bias of the spring in the direction of arrows 730 to a second retracted position. When the trigger 780 is released, the coil spring urges the trigger unit back to its first extended position.

A rocker plate 770 is rotatably mounted in the latch assembly 400 by means of a pivot shaft 771, which is journalled at its ends within appropriate circular holes (not visible) formed in opposing walls of the latch assembly. The rocker plate 770 is thus rotatable about its pivot shaft 771 in a clockwise direction, as indicated by arrow 730, and in the opposite or counterclockwise direction. The rocker plate 770 is formed with a generally “V” or “U” shaped cam slot 772 within which resides a cam shaft 711 of the body 710 of the trigger unit. With this configuration, it will be seen that when the trigger 780 is in its first or extended position, the rocker plate maintained by the cam shaft 711 and slot 772 in a first or active orientation as shown in FIG. 9. However, when the trigger 780 is depressed to the right, the cam shaft 711 also moves to the right. This causes the slot 772 to ride upwardly on the cam shaft and, as a consequence, causes the rocker plate 770 to rotate in a clockwise direction as indicated by arrow 730 to a second or inactive orientation.

The rocker plate 770 is formed with a stop surface 775 at its extreme right hand end in FIG. 9. When the rocker plate is in its active orientation as shown in FIG. 9, the stop surface 775 resides in the path of the finger 434 of the crank gear 430. Thus, an attempt to operate the latch assembly by turning the handle 220 will cause the finger 434 to jam against the stop surface 775 thereby preventing operation of the mechanism, just as with the previously described embodiment. However, when the trigger is depressed, the rocker plate rotates clockwise to its inactive position and its stop surface 775 moves downwardly out of the path of the finger 434. Thus, again as with the previously described embodiment, when the trigger 780 is depressed, the latch mechanism can be operated normally but when it is extended, the latch mechanism cannot be operated. Therefore, the primary function of the embodiment of FIG. 9 is the same as that of the previously described embodiment; however, the anti-activation mechanism itself is somewhat simpler and less complicated. Specifically, since the trigger 780 is coupled to the rocker plate 770 through a slot, rather than an open cam follower surface, the motion of the rocker plate 770 is constrained in both directions of rotation, rather than in only one direction as occurs with the cam and cam follower of the prior embodiment. As a result, both the unit and the rocker plate are biased to their activated positions by a single spring 720 that bears only on the trigger unit.

FIG. 10 illustrates an embodiment of a gliding door unit having four panels where door panels 1281 and 1291 are opened by gliding in directions indicated by the arrows A and B. The four panel unit 1290 includes gliding panels 1291 and 1281 and fixed panels 1282 and 1292. Panels 1281, 1282, 1291, 1292 are mounted within a door frame 1299 that includes a pair of vertical jambs 1293 and 1295, a horizontal head jamb 1294 extending between the upper ends of the vertical jambs 1293 and 1295, and a horizontal sill jamb 1297 extending between the lower ends of the vertical jambs 1293 and 1295. Horizontal sill 1297 further includes a track or other structure to enable the gliding panels 1281 and 1291 to glide between open and closed positions. In the illustrated embodiment, the fixed panels 1282 and 1292 are secured relative to the door frame 1299. Analogous to the two panel unit shown in FIG. 1, a latching mechanism can be provided to lock gliding panel 1292 to vertical jamb 1295 and to lock gliding panel 1282 to vertical jamb 1293. The gliding panel 1291 includes a vertical leading panel portion 1296 and the gliding panel 1281 includes a vertical leading panel portion 1286.

In the embodiment of FIG. 10, the door panel 1291 contains a latch assembly 400 of this invention fitted into leading frame member 1296, and the door panel 1281 contains a keeper assembly 600, also of the invention. Because the keeper assembly 600 is no longer on a fixed jamb, but on door panel 1281, it has increased freedom of movement with respect to the latch assembly 400 as the panels 1281 and 1291 are slid together. This results in a greater likelihood of misalignment between the latch and the keeper. On the other hand, the added freedom of movement also provides some opportunity for correction of misalignment during latching. More particularly, it is useful to provide, in addition to the anti-activation mechanism, an alignment mechanism to correct small misalignments that otherwise might prevent latching as the panels 1281 and 1291 slide shut.

The latch and keeper assemblies of this embodiment are illustrated in greater detail in FIG. 11. It can be seen that they are the same in most respects as the latch and keeper assemblies of the embodiment illustrated in FIG. 2. Accordingly, many features shown in FIG. 11 are not described again in detail here since such descriptions are presented above with reference to FIG. 2. As shown in FIG. 11, the leading member 1286 of the door panel 1281 is provided with a keeper assembly 600. The alignment mechanism for correcting small dislocations in relative height between the doors 1281 and 1291 comprises an alignment pin 618 projecting from the face plate 616. In closing the doors 1281 and 1291, the leading edge of the leading member 1296 passes between the leading edges of the leading member 1286 so as to fit into the keeper channel 520. As the leading member 1296 moves into the channel 520, the alignment pin 618 begins to enter the alignment aperture 61 of the latch assembly 400. If small vertical misalignments occur between the door panels, movement of the pin 618 into the aperture 61 lifts either the leading member 1286 or the leading member 1296 of doors 1281 and 1291, respectively. The lifting action is enhanced by the tapered body of the alignment pin 618, which preferably has a largest diameter that is slightly less than the height dimension of the alignment aperture 61. This lifting corrects the small misalignments and aligns the latch and keeper assemblies for the locking operation. Further, as the alignment pin 618 moves into the alignment aperture 61, it presses against the lower push block surface 83 of the trigger unit within the latch assembly 400 (see also FIGS. 4 and 5). As a result, the anti-activation mechanism is released, in the same way that it is released when the trigger 80 is depressed in the previously described embodiment, so that the latch 450 can be moved into latching engagement with the keeper 560 to secure and latch the doors. It will be apparent that, in this embodiment, the trigger 80 may be eliminated if desired since release of the anti-activation mechanism is accomplished by the alignment pin 618.

According to common practice, the various features of the drawings discussed below are not necessarily drawn to scale. Dimensions of various features and elements in the drawings may be expanded or reduced to more clearly illustrate the embodiments of the invention. Furthermore, the invention has been described herein in terms of preferred configurations and methodologies considered by the inventors to be the best mode of carrying out the invention. These preferred embodiments are presented as examples only and should not be construed as limiting the scope of the invention. A wide variety of additions, deletions, and modifications to the illustrated and described embodiments might be made by those of skill in the art without departing from the spirit and scope of the invention, which is circumscribed only by the claims.

What is claimed is:

1. A gliding door unit comprising:
a door frame having a pair of spaced vertical jambs, a head jamb, and a sill;
a gliding panel mounted in said frame and having a leading frame member;
said gliding panel being slidable within said door frame between an open position and a closed position wherein said leading frame member resides along one of said vertical jambs;
a latch mechanism in said leading frame member;
a keeper assembly in said one of said vertical jambs;
said latch mechanism and said keeper assembly residing adjacent one another when said gliding panel is in its closed position and said latch mechanism being selectively operable to latch said gliding panel to said one of said vertical jambs; and
an anti-activation mechanism in said latch assembly including a depressible trigger extending toward said keeper assembly, said latch assembly being operable when said trigger is depressed and inoperable when said trigger is extended;
said trigger engaging and being depressed by said keeper assembly when said gliding panel is slid shut to allow operation of said latch assembly.

2. A gliding door unit as claimed in claim 1 and further comprising a fault opening in said keeper assembly, said fault opening being positioned such that, in the event of a fault condition, said trigger extends into said fault opening when said gliding panel is slid to its closed position and thus remains extended to render said latch assembly inoperable.

3. A gliding door unit as claimed in claim 2 and wherein said fault condition is a misalignment of said gliding panel with said jamb.

4. A gliding door unit as claimed in claim 3 and wherein said misalignment is a low misalignment of said gliding panel with respect to said jamb.

5. A gliding door unit as claimed in claim 1 and wherein said latch assembly in includes a deployable latch and said keeper assembly includes a keeper, said deployable latch deploying in response to operation of a handle to engage and capture said keeper when said gliding panel is in its closed position.

6. A gliding door unit as claimed in claim 5 and wherein said handle is at least partially prevented from being operated to deploy said latch when said trigger is in its extended position.

7. A gliding door unit as claimed in claim 1 and wherein said keeper assembly includes a strike plate and wherein said trigger engages and is depressed by said strike plate when said gliding door panel is slid shut.

8. A gliding door unit as claimed in claim 7 and further including a target zone on said strike plate, said trigger engaging said strike plate in said target zone when said gliding door panel is properly aligned with said one of said jambs to permit latching.

9. A gliding door unit as claimed in claim 8 and further comprising a fault opening in said strike plate outside of said target zone, said trigger extending into said fault opening and thus not being depressed when said gliding door panel is not properly aligned with said one of said jambs.

10. A gliding door unit as claimed in claim 9 and wherein said fault opening is beneath said target zone so that a low door alignment condition causes said trigger to extend into said fault opening.

11. A latch for a gliding door unit comprising:
a keeper assembly having a strike plate and a keeper;
a latch assembly having a face plate from which a deployable latch can be extended, said latch being configured, when deployed, to capture said keeper when said strike plate and said face plate are adjacent to and substantially aligned with one another;
an anti-activation mechanism in said latch assembly including a depressible trigger projecting from said face plate, said anti-activation mechanism allowing deployment of said latch when said trigger is depressed and substantially preventing deployment of said latch when said trigger is extended;
said trigger being configured to engage and be depressed by said strike plate when said face plate is substantially aligned with and moved toward said strike plate to allow deployment of said latch and capture of said keeper thereby.

12. A latch as claimed in claim 11 and further comprising a fault opening in said strike plate, said fault opening being sized and positioned so that said trigger extends into said fault opening and is thus not depressed when said face plate is substantially misaligned with and moved toward said face plate to prevent deployment of said latch and capture of said keeper thereby.

13. A latch as claimed in claim 12 and wherein said fault opening is positioned so that said trigger extends into said fault opening when said face plate is substantially low with respect to said strike plate.

14. A latch assembly for a gliding door, said latch assembly comprising a housing, a face plate on said housing, a latch deployable from said face plate, a handle selectively operable to deploy and withdraw said latch, and an anti-activation mechanism in said housing including a depressible trigger projecting from said face plate, said anti-activation mechanism allowing operation of said handle to deploy said latch when said trigger is depressed and at least partially preventing operation of said handle when said trigger is not depressed.

15. A latch assembly for a gliding door as claimed in claim 14 and further comprising a keeper assembly complementing said latch assembly and having a strike plate and a keeper, said latch, when deployed, capturing said keeper when said strike plate and said face plate are substantially aligned and closely facing one another and said trigger is depressed by said strike plate.

16. A latch assembly for a gliding door as claimed in claim 15 and further comprising a fault opening in said strike plate, said fault opening being positioned and configured so that said trigger extends into said fault opening when said strike plate and said face plate are misaligned and closely facing one another to prevent operation of said handle under conditions of misalignment.

17. A latch assembly for a gliding door as claimed in claim 16 and wherein said fault opening is position and configured so that said trigger extends into said fault opening when said face plate is misaligned low with respect to said strike plate.
